(19) United States
(12) Patent Application Publication
(10) Pub. No.: US 2015/0373555 A1
(43) Pub. Date: Dec. 24, 2015

(54) Wireless Sensor Network Commissioning

(71) Applicants: Bin Xu, The Woodlands, TX (US); Jason W. Lachance, Magnolia, TX (US); Vasudev Rayachoti, The Woodlands, TX (US); Wayne S. Pon, Calgary (CA)

(72) Inventors: Bin Xu, The Woodlands, TX (US); Jason W. Lachance, Magnolia, TX (US); Vasudev Rayachoti, The Woodlands, TX (US); Wayne S. Pon, Calgary (CA)

(21) Appl. No.: 14/726,003

(22) Filed: May 29, 2015

Related U.S. Application Data
(60) Provisional application No. 62/015,813, filed on Jun. 23, 2014.

(51) Int. Cl. H04W 16/18; H04W 64/00; H04W 4/02; H04W 4/00; H04L 12/24; H04W 24/10

(52) U.S. Cl. CPC H04W 16/18; H04L 41/0803; H04W 24/10; H04W 4/02; H04W 4/005; H04W 64/003; H04W 88/16

(57) ABSTRACT

A communications apparatus configured to communicate with a sensor network, comprising a transmitter, a receiver, a processor coupled to the transmitter and the receiver, and a memory coupled to the processor, wherein the memory comprises instructions that when executed by the processor cause the apparatus to retrieve configuration data from the memory regarding the sensor network, wherein the configuration data is preloaded on the memory at a first physical location prior to installing the apparatus at a second physical location, select a wireless communication gateway from a plurality of communication gateways in the sensor network based at least in part on the configuration data, and wirelessly transmit data to the wireless communication gateway, wherein the data comprises information indicating a sensor reading.

### CROSS REFERENCE TO RELATED APPLICATIONS

This application claims the priority benefit of both U.S. patent application No. 62/015,813 filed Jun. 23, 2014 entitled WIRELESS SENSOR NETWORK COMMISSIONING, the entirety of which is incorporated by reference herein.

### BACKGROUND

Maintenance of an industrial process sensor network may present various challenges. One problem may be the ability to obtain real or near-real time control and monitoring of machines that carry on processes and sensors for monitoring or tracking the performance of these machines. Conventional solutions include constructing and commissioning wired transmitters, which are electrically connected to a control system, e.g., a Distributed Control System (DCS), a programmable logic controller (PLC), etc., in the field. Such solutions include the following two approaches: (a) configuring a database of wired transmitters from the control system, or (b) creating an off-line database of transmitters in the control system at an engineering facility and downloading the database to transmitters following wired connection in the field.

Various wireless network technologies are known and used for measurement data collection. Advantages of wireless sensor network technology include the lack of wiring and thus reduce cost of cabling, junction boxes, trenches, and I/O connections. In addition, wireless sensor network technology may reduce the commissioning time of field sensors. However, wireless sensor networks and wireless handheld devices may utilize different communication protocol. For example, wireless sensor network may employ wireless sensor network standards such as Wireless HART ISA100.11a, and other standard or proprietary wireless protocols. Further, current solutions require significant on-site installation activity by maintenance personnel. For example, maintenance personnel may have to spend significant time programming a device on-site based on variances in signal strength, accessibility, wiring and/or power requirements, etc. These and other difficulties make existing solutions for on-site or field sensor commissioning unattractive.

### SUMMARY

One embodiment includes a communications apparatus configured to communicate with a sensor network, comprising a transmitter, a receiver, a processor coupled to the transmitter and the receiver, and a memory coupled to the processor, wherein the memory comprises instructions that when executed by the processor cause the apparatus to retrieve configuration data from the memory regarding the sensor network, wherein the configuration data is preloaded on the memory at a first physical location prior to installing the apparatus at a second physical location, select a wireless communication gateway from a plurality of communication gateways in the sensor network based at least in part on the configuration data, and wirelessly transmit data to the wireless communication gateway, wherein the data comprises information indicating a sensor reading.

Another embodiment includes a method for commissioning a communications apparatus in a wireless network, comprising defining a geographic area for a gateway, determining a placement position for the communications apparatus within the geographic area, configuring the communications apparatus with a placement position information at a first physical location, installing the communications apparatus at a second physical location, wherein the second physical location is geographically remote from the first physical location; and initiating wireless communications between the communications apparatus and the gateway.

Still another embodiment includes a system for collecting measurement data, comprising a gateway configured to send and receive wireless communications, a plurality of communications apparatuses configured to send and receive wireless communications to the gateway according to an apparatus-specific predefined configuration data, wherein the apparatus-specific predefined configuration data is loaded onto a memory of each of the plurality of communications apparatuses at a first location geographically remote from an installation location, and wherein each of the plurality of communications apparatuses is configured to measure temperature, pressure, valve position, device position, flow, composition, conductivity, resistivity, differential pressure, mass spectrometry, humidity, density, level, angle, light, amps, voltage, weight, or magnetic field, and a control system configured to communicate with the gateway.

### BRIEF DESCRIPTION OF THE DRAWINGS

The advantages of the present techniques are better understood by referring to the following detailed description and the attached drawings, in which:

FIG. 1 is a schematic diagram of a wireless sensor network.

FIG. 2 is a flowchart showing a process for commissioning a communications apparatus in a wireless network.

FIG. 3 is a block diagram of a general purpose computer system.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described herein, but rather, include all alternatives, modifications, and equivalents falling within the true spirit and scope of the appended claims.

This disclosure comprises techniques to install and/or commission wireless communications transmitters on-site in a field setting with minimal maintenance team involvement. Techniques for commissioning wireless transmitters disclosed herein include selecting field placement positions for the wireless transmitters with known characteristics, preloading the wireless transmitters with the characteristic data for the particular preselected field placement, and initiating communications with equipment configured to wirelessly interact with the wireless communications transmitters. Using the techniques disclosed herein can shorten the commissioning and/or installation time for wireless transmitters to increase overall cost efficiency and personnel usage efficiency.

At the outset, for ease of reference, certain terms used in this application and their meanings as used in this context are set forth. To the extent a term used herein is not defined herein, it should be given the broadest definition persons in the pertinent art have given that term as reflected in at least one printed publication or issued patent. Further, the present techniques are not limited by the usage of the terms shown herein, as all equivalents, synonyms, new developments, and terms or techniques that serve the same or a similar purpose are considered to be within the scope of the present claims.

As used herein, the term “computer component” refers to a computer-related entity, namely, hardware, firmware, software, a combination thereof, or software in execution. For example, a computer component can be, but is not limited to being, a process running on a processor, a processor, an object, an executable, a thread of execution, a program, and a computer. One or more computer components can reside within a process and/or thread of execution and a computer component can be localized on one computer and/or distributed between two or more computers.

As used herein, the terms “computer-readable medium,” “non-transitory, computer-readable medium” or the like refer to any tangible storage that participates in providing instructions to a processor for execution. Such a medium may take many forms, including but not limited to, non-volatile media, and volatile media. Non-volatile media includes, for example, Non-Volatile Random Access Memory (NVRAM), or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a Compact Disk Read Only Memory (CD-ROM), any other optical medium, a Random Access Memory (RAM), a synchronous RAM (SRAM), a dynamic random-access memory (DRAM), a synchronous dynamic RAM (SDRAM), a Programmable ROM (PROM), and Electrically Programmable ROM (EPROM), Electrically Erasable and Programmable ROM (EEPROM), a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible, non-transitory storage medium or tangible distribution medium and prior art-recognized equivalents and successor media, in which the software implementations embodying the present techniques are stored.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on. Wireless computer communications may utilize one or more of a plurality of communication protocols. Suitable wireless sensor network communications standards include Wireless HART, ISA100.11a, and other open or proprietary wireless protocols.

“Data store,” as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic” or “logical,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted and/or detected.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servlet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

A “process” as used herein with respect to computer components is generally conceived to be a sequence of processor or computer-executable steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc., which are often associated with manual operations performed by a human operator. It is understood that no such involvement of a human operator is necessary or even desirable in the present invention. The operations described herein are machine operations performed in conjunction with human operators) or users) who interact with the computer(s). The machines used for performing the operation of the present invention include general digital computers or other similar processing devices.

In addition, it should be understood that the programs, processes, methods, etc., described herein are not related or limited to any particular computer or apparatus. Rather, various types of general purpose machines may be used with programs constructed in accordance with the teachings described herein. Similarly, it may prove advantageous to construct specialized apparatus to perform at least a portion of the techniques described herein by way of dedicated computer systems with hard-wired logic or programs stored in nonvolatile memory, such as read only memory.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

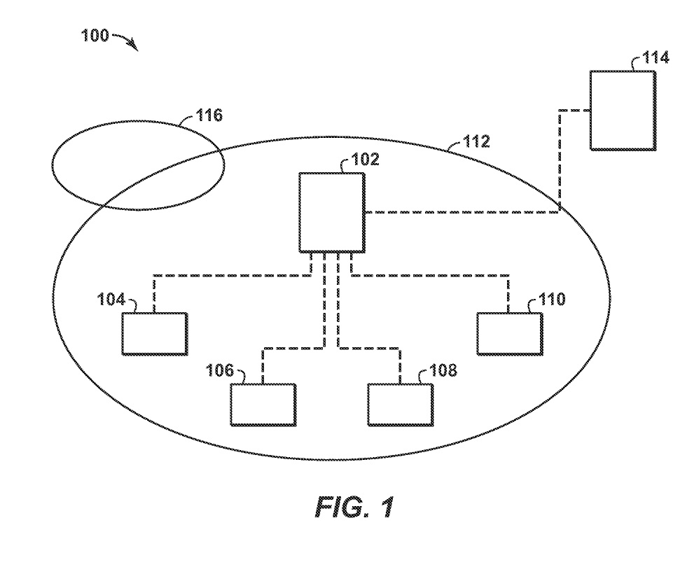

FIG. 1 is a schematic diagram of a wireless sensor network 100. The network 100 may be comprised within a control network (not depicted), e.g., for industrial process, machine health, environmental condition, etc. monitoring and/or control. In some embodiments, the network 100 may be one of a plurality of sensor networks within a control network. The network 100 comprises a plurality of network nodes 102-110, 114. While singular wireless communications lines are depicted, those of skill in the art will understand that alternate or additional communications pathways may be implemented, e.g., as a mesh network, an at least partially wired network, etc. The network nodes 102-110, 114 may comprise any device(s) that communicates signals, data, and/or contents through a network 100 using a communications protocol, e.g., Ethernet, Internet Protocol (IP), or Transmission Control Protocol (TCP). In an embodiment, the network nodes 102-110, 114 may consist essentially of wireless computer communication signal processing devices, such as routers, servers, hubs, switches, transmitters, receivers, transceivers, and so forth, or a combination thereof. In some embodiments, the network nodes 102-110, 114 are configured to be operatively coupled, affixed, or otherwise attached to separate components, e.g., sensors, meters, tanks, pipes, valves, etc. The network nodes 102-110, 114 may be discussed separately hereafter, but it will be understood that each separately discussed network node may have one or more feature described above.

The gateway 102 is in computer communication, e.g., wireless communication with the network nodes or communications apparatuses 104-110 in a geographic area 112, as indicated by the first dashed lines. The computer communication between the gateway 102 and the communications apparatuses 104-110 may include an exchange of identification (ID), e.g., a gateway ID, a network ID, a sensor ID for a monitored sensor or other component, an ID for each communications apparatus 104-110, a key exchange, e.g., a join key, a token ring, a private key, a public key, etc., or other communications mechanisms as known in the art. Each of the communications apparatuses 104-110 may have a predetermined placement position, e.g., a location adjacent a sensor or other component, within the geographic area 112, e.g., within an oil field, on a drilling rig, etc. The gateway 102 is also in computer communication according to an Open Platform Communication (OPC), Modbus, or other protocol known in the art, e.g., wireless or wired (physical) communication, with a control system 114, e.g., a Distributed Control System (DCS) running Asset Management System (AMS) or similar software, a programmable logic controller (PLC), etc., as indicated by the second dashed line. In some embodiments, the communications protocol(s) between the gateway 102 and the communications apparatuses 104-110 may differ from the communications protocol(s) between the gateway 102 and the control system 114. In such embodiments, the gateway 102 may be configured to communicate over a plurality of communications protocols.

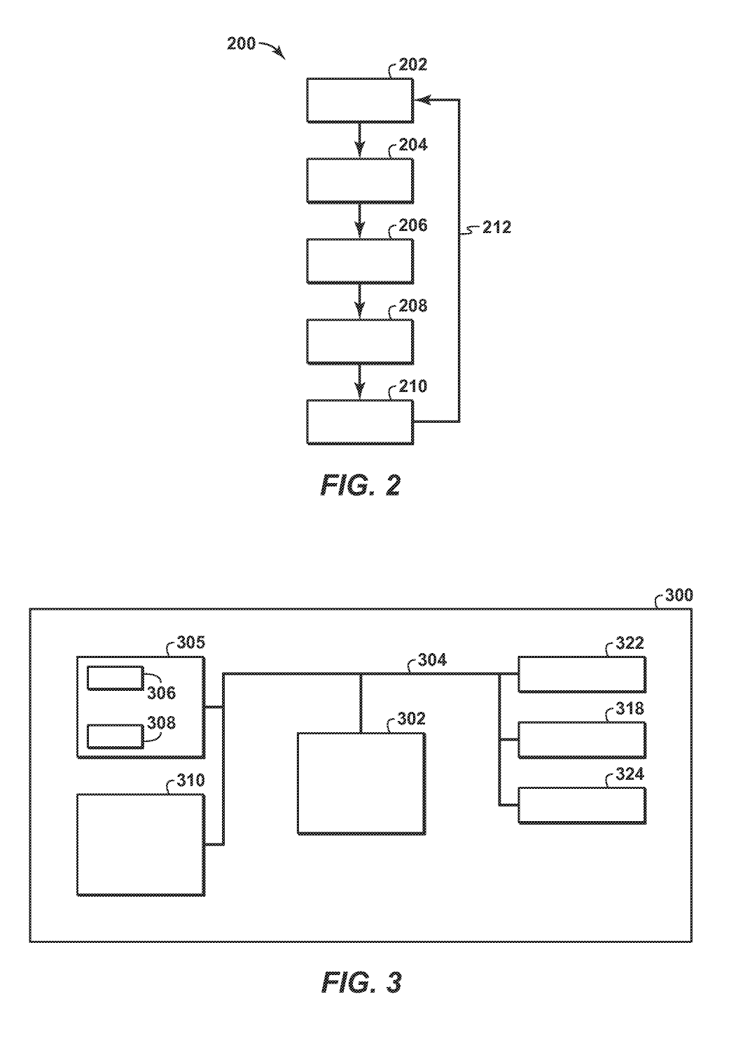

FIG. 1 further includes a physical location 116 that is geographically separated from the physical locations of the communications apparatuses 104-110. The physical location 116 is depicted both within and without the geographic area 112. The purpose of depicting the physical location 116 in this manner is to indicate that in some embodiments the physical location 116 is entirely within the geographic area 112, in other embodiments the physical location 116 is entirely outside of the geographic area 112, and in still other embodiments the physical location 116 is partially within the geographic area 112. In some embodiments, the physical location 116 may comprise less than all of the communications apparatuses 104-110 within the scope of this disclosure. The physical location 116 represents a first physical location, e.g., a bench top in an onshore facility, wherein communications apparatuses may be preloaded with certain information, e.g., predefined configuration data and/or placement information as described in connection with FIG. 2, prior to shipping and/or installation at a second physical location, e.g., an offshore platform facility. The first physical location and the second physical location are geographically remote, which as used herein means separated by a distance having a lower bound and an upper bound, wherein the lower bound is 1 meter (m), 10 m, 100 m, 1 km, or 10 km, and wherein the upper bound is 1 km, 10 km, 100 km, 1,000 km, or 12,500 km. In one embodiment, geographically remote means separated by a distance between 1 km-12,500 km.

FIG. 2 is a flowchart showing a process 200 for commissioning a communications apparatus, e.g., any communications apparatus 104-110 of FIG. 1, in a wireless network, e.g., network 100 of FIG. 1. The process 200 may begin at block 202 with defining a geographic area, e.g., the geographic area 112 of FIG. 1, for a gateway, e.g., the gateway 102 of FIG. 1. While the process 200 assumes a preexisting gateway, it will be understood that the gateway maybe installed and placed online in conjunction with one or more of the steps below. Further, the process 200 assumes that the gateway is operatively coupled to a control system, e.g., the control system 114 of FIG. 1. At block 204, the process 200 may continue with determining a placement position for the communications apparatus within the geographic area. Considerations for determining the placement position of the communications apparatus may include considering the position of the sensor or other component desired to be monitored, the physical contours of the geographic area or any obstructions, etc., therein, the compatibility of the communications apparatus with the gateway, the transmission strength of the gateway, transmission strength of the communications apparatus, the architecture of the network, etc. The steps performed in blocks 202-204 may be performed in any order or in any location. At block 206, the process 200 includes configuring the communications apparatus with the predefined configuration data and/or placement information, e.g., by loading preset information into a memory for the communications apparatus, at a first physical location, e.g., the physical location 116 of FIG. 1. In some embodiments, the predefined configuration data and/or placement information is information specifying one or more mechanisms for communication within the geographic area. For example, in some embodiments the predefined configuration data and/or placement information comprises a join key, a sensor ID, a network ID, a sampling rate, or like data. These and other data may be considered predefined configuration data and/or placement information as they may provide, inter alia, indication which gateway among a plurality of gateways within a network, which network among a plurality of networks, or which control system among a plurality of control systems in conjunction with which the communications apparatus is being utilized. Other embodiments may include various other parameters among the predefined configuration data and/or placement information, e.g., an expected gateway signal strength, a required transmission power strength, a data transmission format, a data transmission protocol, a data transmission timing window and/or periods of operation, etc. At block 208, the process 200 includes installing the communications apparatus in a second physical location according to the placement position determined under block 204. Installation may include connecting the communications apparatus to a power source, e.g., a battery or an electrical outlet, and may further include operatively coupling, affixing, or otherwise attaching the communications apparatus to the sensor or component for which monitoring is intended. In some embodiments, installation includes confirming the signal strength of the wireless communications originating at the communications apparatus, the signal of the wireless communications originating at the gateway, or both. As would be apparent to those of skill in the art, the sensor or component for which monitoring is intended may be replaced for reasons of maintenance, upgrading, repair, or replacement according and (re)connected to the communications apparatus in like manner. These and such alternate operations are within the scope of this disclosure. At block 210, the process 200 includes initiating wireless communications between the communications apparatus and the gateway. This may include connecting one or more communications apparatuses to the gateway and performing one or more additional configuration operations to ensure that the communications apparatuses are capable of passing data via the gateway to the control system. As indicated by line 212, the process 200 may be repeated to add additional communications apparatuses. As will be understood, one or more of the steps of the process 200 may be performed concurrently, mutatis mutandis, when a plurality of communications apparatuses are being installed. Those of skill in the art will recognize that in such embodiments a plurality of physical locations may be suitably employed for loading predefined configuration data and/or placement information within the scope of this disclosure.

FIG. 3 is a block diagram of a general purpose computer system 300 suitable for implementing one or more embodiments of the components described herein. The computer system 300 comprises a central processing unit (CPU) 302 coupled to a system bus 304. The CPU 302 may be any general-purpose CPU or other types of architectures of CPU 302 (or other components of exemplary system 300), as long as CPU 302 (and other components of system 300) supports the operations as described herein. Those of ordinary skill in the art will appreciate that, while only a single CPU 302 is shown in FIG. 3, additional CPUs may be present. Moreover, the computer system 300 may comprise a networked, multi-processor computer system that may include a hybrid parallel CPU/Graphics Processing Unit (GPU) system (not depicted). The CPU 302 may execute the various logical instructions according to various embodiments. For example, the CPU 302 may execute machine-level instructions for performing processing according to the operational flow described above in conjunction with FIG. 2.

The computer system 300 may also include computer components such as non-transitory, computer-readable media or memory 305. The memory 305 may include a RAM 306, which may be SRAM, DRAM, SDRAM, or the like. The memory 305 may also include additional non-transitory, computer-readable media such as a Read-Only-Memory (ROM) 308, which may be PROM, EPROM, EEPROM, or the like. RAM 306 and ROM 308 may hold user data, system data, data store(s), process(es), and/or software, as known in the art. The memory 305 may suitably store predefined configuration data and/or placement information, e.g., predefined configuration data and/or placement information as described in connection with FIG. 2. The computer system 300 may also include an input/output (I/O) adapter 310, a communications adapter 322, a user interface adapter 324, and a display adapter 318.

The I/O adapter 310 may connect one or more additional non-transitory, computer-readable media such as an internal or external storage device(s) (not depicted), including, for example, a hard drive, a compact disc (CD) drive, a digital video disk (DVD) drive, a floppy disk drive, a tape drive, and the like to computer system 300. The storage device(s) may be used when the memory 305 is insufficient or otherwise unsuitable for the memory requirements associated with storing data for operations of embodiments of the present techniques. The data storage of the computer system 300 may be used for storing information and/or other data used or generated as disclosed herein. For example, storage device(s) may be used to store configuration information or additional plug-ins in accordance with an embodiment of the present techniques. Further, user interface adapter 324 may couple to one or more user input devices (not depicted), such as a keyboard, a pointing device and/or output devices, etc. to the computer system 300. The CPU 302 may drive the display adapter 318 to control the display on a display device (not depicted), e.g., a computer monitor or handheld display, to, for example, present information to the user regarding location.

The computer system 300 further includes communications adapter 322. The communications adapter 322 may comprise one or more separate components suitably configured for computer communications, e.g., one or more transmitters, receivers, transceivers, or other devices for sending and/or receiving signals. The computer communications adapter 322 may be configured with suitable hardware and/or logic to send data, receive data, or otherwise communicate over a wired interface or a wireless interface, e.g., carry out conventional wired and/or wireless computer communication, radio communications, near field communications (NFC), optical communications, scan an RFID device, or otherwise transmit and/or receive data using any currently existing or later-developed technology. In some embodiments, the communications adapter 322 is configured to receive and interpret one or more signals indicating location, e.g., a GPS signal, a cellular telephone signal, a wireless fidelity (Wi-Fi) signal, etc.

The architecture of system 300 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. Additional alternative computer architectures may be suitably employed, e.g., utilizing one or more operably connected external components to supplement and/or replace an integrated component. In fact, persons of ordinary skill in the art may use any number of suitable structures capable of executing logical operations according to the embodiments. In an embodiment, input data to the computer system 300 may include various plug-ins and library files. Input data may additionally include configuration information.

While the present techniques may be susceptible to various modifications and alternative forms, the exemplary embodiments discussed herein have been shown only by way of example. However, it should again be understood that the techniques disclosed herein are not intended to be limited to the particular embodiments disclosed. Indeed, the present techniques include all alternatives, modifications, combinations, permutations, and equivalents falling within the true spirit and scope of the appended claims.

1. A communications apparatus configured to communicate with a sensor network, comprising:
a transmitter;
a receiver;
a processor coupled to the transmitter and the receiver; and
a memory coupled to the processor, wherein the memory comprises instructions that when executed by the processor cause the apparatus to:
retrieve configuration data from the memory regarding the sensor network, wherein the configuration data is preloaded on the memory at a first physical location prior to installing the apparatus at a second physical location;
select a wireless communication gateway from a plurality of communication gateways in the sensor network based at least in part on the configuration data; and
wirelessly transmit data to the wireless communication gateway, wherein the data comprises information indicating a sensor reading.

2. The apparatus of claim 1, wherein the sensor reading indicates temperature, pressure, valve position, device position, flow, composition, conductivity, resistivity, differential pressure, mass spectrometry, humidity, density, level, angle, light, amps, voltage, weight, or magnetic field.

3. The apparatus of claim 1, wherein the configuration data comprises a join key, a sensor identification (ID), a network ID, or a sampling rate.

4. The apparatus of claim 1, wherein the communications apparatus further comprises a battery.

5. The apparatus of claim 1, wherein the configuration data comprises a network ID selected from a plurality of network IDs, and wherein the network ID is assigned to the wireless communication gateway.

6. A method for commissioning a communications apparatus in a wireless network, comprising:
defining a geographic area for a gateway;
determining a placement position for the communications apparatus within the geographic area;
configuring the communications apparatus with a placement position information at a first physical location;
installing the communications apparatus at a second physical location, wherein the second physical location is geographically remote from the first physical location; and
initiating wireless communications between the communications apparatus and the gateway.

7. The method of claim 6, further comprising:
determining a second placement position for a second communications apparatus within the geographic area;
configuring the second communications apparatus with a second placement position information at the first physical location;
installing the communications apparatus at a third physical location, wherein the third physical location is geographically remote from the first physical location and the second physical location; and
initiating wireless communications between the second communications apparatus and the gateway.

8. The method of claim 6, wherein the gateway is selected from a plurality of gateways in the wireless network.

9. The method of claim 8, wherein the gateway is physically coupled to a control system, wherein the control system is a Distributed Control System (DCS) or a programmable logic controller (PLC).

10. The method of claim 9, wherein the gateway is wirelessly coupled to a control system, wherein the control system is a Digital Control System (DCS) or a programmable logic controller (PLC).

11. The method of claim 10, further comprising confirming the wireless compatibility between the gateway and the communications apparatus and between the gateway and the control system.

12. The method of claim 6, wherein determining the placement position is based at least in part on the transmission strength of the communications apparatus.

13. The method of claim 6, wherein determining the placement position is based at least in part on the transmission strength of the gateway.

14. The method of claim 6, wherein the placement position information comprises a join key, a sensor identification (ID), a network ID, or a sampling rate.

15. The method of claim 6, wherein installing the communications apparatus comprises confirming the signal strength of the wireless communications originating at the communications apparatus, the signal of the wireless communications originating at the gateway, or both.

16. The method of claim 6, wherein selecting the communications apparatus comprises a sensor measuring temperature, pressure, valve position, device position, flow, composition, conductivity, resistivity, differential pressure, mass spectrometry, humidity, density, level, angle, light, amps, voltage, weight, or magnetic field.

17. A system for collecting measurement data, comprising:
a gateway configured to send and receive wireless communications;
a plurality of communications apparatuses configured to send and receive wireless communications to the gateway according to an apparatus-specific predefined configuration data, wherein the apparatus-specific predefined configuration data is loaded onto a memory of each of the plurality of communications apparatuses at a first location geographically remote from an installation location, and wherein each of the plurality of communications apparatuses is configured to measure temperature, pressure, valve position, device position, flow, composition, conductivity, resistivity, differential pressure, mass spectrometry, humidity, density, level, angle, light, amps, voltage, weight, or magnetic field; and
a control system configured to communicate with the gateway.

18. The system of claim 17, wherein the control system communicates with the gateway via a wired connection.

19. The system of claim 17, wherein the control system communicates with the gateway via a wireless communication.

20. The system of claim 19, wherein the apparatus-specific predefined configuration data comprises an expected gateway signal strength, a transmission power strength, a data transmission format, a data transmission timing windows, a period of operation, or a combination thereof.
